(19) United States
(12) Patent Application Publication
(10) Pub. No.: US 2026/0371018 A1
(43) Pub. Date: Nov. 19, 2026

(54) METHOD FOR DIRECTIONAL NOISE SUPPRESSION IN A HEARING DEVICE, AND HEARING DEVICE

(71) Applicant: Sivantos Pte. Ltd., Singapore (SG)

(72) Inventors: Tobias Daniel Rosenkranz, Erlangen (DE); Michael Bürger, Erlangen (DE); Sandro Kecanovic, Erlangen (DE)

(21) Appl. No.: 19/212,089

(22) Filed: May 19, 2025

(51) Int. Cl. H04R 25/00

(52) U.S. Cl. CPC H04R 25/407; H04R 25/405; H04R 25/505

(57) ABSTRACT

A method for directional noise suppression in a hearing device. The hearing device has an acousto-electric first input transducer configured to generate a first input signal from an environment sound and an acousto-electric second input transducer configured to generate a second input signal from the environment sound. The method includes the following steps: (a) determining, based on at least one of the first input signal and the second input signal, a control parameter that characterizes a stationarity of a noise component in the environment sound; (b) deriving a beamformer signal from the first and second input signals by a beamformer, which is configured to attenuate a contribution of a noise component in the environment represented in at least one of the first input signal and the second input signal; and (c) controlling an adaptation speed of the beamformer based on the control parameter.

### FIELD AND BACKGROUND OF THE INVENTION

The invention relates to a method for directional noise suppression in a hearing device, said hearing device comprising at least an acousto-electric first input transducer configured to generate a first input signal from an environment sound and an acousto-electric second input transducer configured to generate a second input signal from said environment sound. A beamformer generates a beamformer signal from the first input signal and from the second input signal. The invention further relates to a hearing device configured to perform the method for directional noise suppression.

Generally, a hearing device is an electronic device that is designed to support the hearing of person wearing it (referred to as a user or wearer of the hearing device). While not limiting, the invention in particular relates to a hearing aid, i.e., a hearing device that is specifically configured to at least partially compensate for the hearing impairment of a hearing-impaired user. Other types of hearing devices can be designed to support the hearing of normal hearing users, i.e., to improve speech perception in complex acoustic situations, or also communication devices. Furthermore, the term hearing device, as used herein, may relate to a device for streaming an audio signal such as speech or music, e.g. a headset, headphone, ear buds, etc.

Hearing devices in general, and hearing aids in particular, are usually designed to be worn on the head, and in this case in particular on the head or on one of the user's ears, especially as behind-the-ear devices (BTE devices) or in-the-ear devices (ITE devices). With respect to its internal structure, a hearing device normally comprises an (acousto-electric) input transducer, a signal processor and an output transducer. During operation of the hearing device, the input transducer captures a sound signal from an environment of the hearing device and converts it into an input audio signal (i.e., an electric signal transporting a sound information).

In the signal processor, the captured sound signal (i.e., input audio signal) is processed, in particular amplified dependent on sound frequency, to support the hearing of the user, in particular to compensate a hearing-impairment of the user, to suppress ambient noise, etc. The signal processor outputs a processed audio signal (also called processed sound signal) to the output transducer. Most often, the output transducer is an electro-acoustic transducer (also called “receiver”) that converts the processed sound signal into a processed air-borne sound, which is emitted into the ear canal of the user. Alternatively, the output transducer may be an electro-mechanical transducer that converts the processed sound signal into a structure-borne sound (vibrations) that is transmitted, e.g., to the cranial bone of the user. Furthermore, besides classical hearing devices as described before, there are implanted hearing devices such as cochlear implants, and hearing devices the output transducers of which output the processed sound signal by directly stimulating the auditory nerve of the user.

One part of the aforementioned signal processing is often given by noise reduction, as environmental noise may compromise the ability of a hearing-impaired user to understand useful signals such as speech contributions. There are different strategies for such a noise reduction, some of which are based on directional signal processing of at least two different input signals that are generated at different locations in the hearing device, in order to be able to “mute” certain spatial regions which contain more noise. However, in the case of non-stationary noise, typical noise reduction algorithms do not perform well even in case of directional signal processing being employed.

### SUMMARY OF THE INVENTION

The invention is based on the object of providing a method for directional noise suppression in a hearing device which should be easy and resource-efficient to implement and at the same time should allow for the particular attenuation of non-stationary interferers. The invention is also based on the object of providing a corresponding hearing device.

With the above and other objects in view there is provided, in accordance with the invention, a method for directional noise suppression in a hearing device, which has a first acousto-electric input transducer configured to generate a first input signal from an environment sound and a second acousto-electric input transducer configured to generate a second input signal from the environment sound. The method comprises the following method steps: determining, on a basis of at least one of the first input signal or the second input signal, a control parameter that characterizes a stationarity of a noise component in the environment sound; deriving a beamformer signal from the first input signal and from the second input signal by a beamformer, the beamformer signal being configured to attenuate a contribution of a noise component in the environment represented in at least one of the first input signal or the second input signal; and controlling an adaptation speed of the beamformer on a basis of the control parameter.

According to the invention, the object is achieved in terms of the method by the features of the independent method claim, and in terms of the hearing device by the features as claimed. The advantages and embodiments mentioned regarding the method can be expediently transferred to the hearing device, and vice versa.

In other words, the objects of the invention are achieved by the novel method for directional noise suppression in a hearing device, which comprises at least an acousto-electric first input transducer configured to generate a first input signal from an environment sound and an acousto-electric second input transducer configured to generate a second input signal from said environment sound. The method comprises the steps of: (a) determining, on the basis of at least one of the first input signal and the second input signal, a control parameter, said control parameter characterizing a stationarity of a noise component in the environment sound, (b) deriving a beamformer signal from the first input signal and from the second input signal by means of a beamformer, said beamformer signal being configured to attenuate a contribution of a noise component in the environment represented in at least one of the first input signal and the second input signal, and (c) controlling an adaptation speed of said beamformer on the basis of said control parameter.

With the above and other objects in view there is also provided, in accordance with the invention, a hearing device, comprising at least an acousto-electric first input transducer and an acousto-electric second input transducer, and at least one signal processing unit, wherein said first input transducer is configured to generate a first input signal from an environment sound, wherein said second input transducer is configured to generate a second input signal from an environment sound, and wherein said signal processing unit is configured to perform the aforementioned method.

As indicated above, the notion of a hearing device may generally comprise any device which is configured to generate an output sound signal from an electrical signal, which in turn is derived from an electric input signal generated by means of a corresponding input transducer, and to feed said output sound signal to the hearing of a wearer (a user) of this device, i.e., in particular headphones (e.g., as an “earbud”), a headset, data glasses with loudspeakers, etc., being equipped with an input transducer as specified. In the present context, at least two such input transducers are provided in the hearing device, generating to corresponding input signals.

However, a hearing device may also comprise a hearing aid in the “stricter” sense, i.e., a device configured for compensating, at least partially, a hearing impairment of the wearer, and in which the input signal generated from an environment sound signal by means of said input transducer is processed into an output signal and in particular amplified frequency band-wise in a user-specific manner and preferably in dependence on the audiological needs of the wearer. The output sound signal is then generated from the output signal by means of an output transducer (e.g., a loudspeaker or the like), and is suitable for said at least partial compensation of the hearing impairment of the wearer.

In recent times, solutions have been provided where parts of the above-mentioned signal processing are performed by an auxiliary device such as a smart phone or a smart watch specifically configured for interacting with the aforementioned hearing device-- together forming a hearing system. In the following, the term hearing device shall also comprise such a hearing system comprising a head-worn unit (the “hearing device” in its stricter sense) and an auxiliary unit performing some of the signal processing.

The hearing device may be a monaural device, configured to be worn by a user at an ear. However, the hearing device may also be a binaural hearing system comprising a first local device and a second local device, each local device to be worn by the user at one of their ears. In the latter case, preferably, the first input transducer is located in the first local device and the second input transducer is located in the second local device, wherein the second input signal or an intermediate signal derived therefrom is transmitted to the first local device for the generation of the beamformer signal.

The notion of an acousto-electrical input transducer in particular comprises any device that is configured to generate an electrical signal from a sound signal. In particular, when the first input signal is generated by the input transducer, there may also be pre-processing, e.g. in the form of linear pre-amplification and/or A/D conversion. The input signal is in particular given by an electrical signal whose current fluctuations and/or voltage fluctuations essentially represent the sound pressure fluctuations of the air, possibly in an already digitalized form.

In order to perform the method, the hearing device in particular may be equipped with suitable signal processing means such as one or several digital signal processors, volatile memory (RAM), one or several hardwired circuits (ASICs), and the like. The entirety of these signal processing means shall be denoted as a signal processing unit, which may be implemented in one single integrated chipset, or may comprise various components.

The notion of a directional noise suppression in particular comprises any direction-dependent signal processing of the two input signals, resulting in a processed signal having, in general, a non-trivial directional characteristic, wherein the signal processing is configured to suppress a signal contribution in at least one of the first and the second input signal that is considered to be noise, i.e., representing noise of any form in the environment sound.

The notion of deriving the beamformer signal from the first and second input signal in particular comprises that signal components from these two input signals enter into the beamformer signal, possibly with a different frequency-dependent amplification and/or compression (or even clipping) for the components of each of the input signals. This means that the first or second input signal is not just a control signal on which some control value is measured for processing of the beamformer signal, but preferably, there exists a mapping and/or a transfer function between the two input signals and the beamformer signal. The beamformer signal may be generated directly from the first and the second input signal by means of an appropriate time-delay being applied to one of the two input signals and a subsequent (weighted) superposition of the time-delayed input signal and the remaining (non-delayed) input signal. However, the two input signals may also be used to derive one or more intermediate signals with non-trivial directional characteristics, e.g., a cardiod-shaped and/or an anti-cardiodid-shaped intermediate signal, such that said beamformer signal is derived from the intermediate signal(s). Furthermore, other types of beamforming of the input signals, such as minimum variance distortionless response (MVDR) or linear-constraint minimum-variance (LCMV) are also possible in the signal processing for generating the beamformer signal.

By its design and construction, the beamformer signal is configured to attenuate a contribution of a noise component in the environment represented in at least one of the first input signal and the second input signal. This means that the beamformer builds the beamformer signal from the first and second input signal (or from respective intermediate signals) in a way that the contributions of a noise component of the environment that are represented in any of the input signals are attenuated. This may be achieved, e.g., by minimizing the acoustic energy of the beamformer signal under the constraint that the sensitivity of the beamformer signal in a target direction (which may be given, e.g., by the frontal direction of the user of the hearing device) shall have a predetermined value, or shall not fall below a predetermined threshold. If there is more than one noise source present in the environment, the beamformer may be configured to prioritize the attenuation of the contributions of one of the noise sources in the input signals, in a way yet to be described.

The beamformer signal is updated, preferably with regular periodicity, such that the beamformer may adapt to changes of the noise present in the environment. This means that any superposition weights and/or delay times used to combine the first and second input signal or to combine respective intermediate signals derived from the input signals, may get updated with the frequency of said periodicity, as well. Preferably, the beamformer signal may use the most recent parameter set of superposition weights and delay times until the next update, while combining the instantaneous signal components of the first and second input signals (or of the respective intermediate signals).

The notion of determining a control parameter, on the basis of at least one of the first input signal and the second input signal in particular comprises that the control parameter is obtained from a measurement on the first input signal, or from a measurement on the second input signal, or from a measurement on an intermediate signal derived from the first and the second input signal. Preferably, the control parameter is obtained from a measurement on a directional signal with limited sensitivity in the target direction, such as, most preferably, an intermediate signal derived from both input signals which has an anti-cardioid-shaped directional characteristic (i.e., has ideally zero sensitivity in the target direction), as this limits the influence of a target signal from the target direction on the control parameter. Furthermore, the control parameter may be obtained as one of a mean value, a maximum value and a minimum value of the measurement on the first input signal and the measurement on the second input signal.

The control parameter characterizes a stationarity of a noise component in the environment sound. The notion of stationarity comprises a variation, preferably a relative variation, of an acoustic energy emitted by the noise source, and reflected in a signal level and/or in a signal energy of the respective input signals representing the noise component. In particular, said variation may be assessed frequency band-wise. The notion of stationarity may further comprise a variation of a pitch and/or of a lowest frequency component. So, preferably, the control parameter is obtained by way of a measurement of said signal level and/or frequency variation on one of the aforementioned signals.

The notion of controlling an adaptation speed of said beamformer on the basis of said control parameter in particular comprises that the speed with which the beamformer signal is adapting to a change of the noise present in the environment is controlled by means of the control parameter. This may be achieved by changing an updating periodicity of the beamformer in dependence on the control parameter. However, preferably, the adaptation speed is controlled by means of a step size used during the updating process, said step size being dependent on the control parameter.

The invention has the specific advantage that, in the case of more than only one noise source, and in particular, noise sources with (possibly significantly) different stationarity, the stationary noise may also be reduced by a single channel (i.e., non-directional) signal processing employing Wiener filters, spectral subtraction, or the like. Then, the invention allows for the beamformer adapting to a noise source with a lower stationarity by controlling the adaptation speed in dependence on the stationarity of the noise present in the first and/or second input signals. In particular, for the control parameter indicating a low stationarity of noise, the adaptation speed of the beamformer may be set faster in order to properly adapt to the non-stationary noise, for the control parameter indicating a higher stationarity of noise, the adaptation speed of the beamformer may be set slower.

Preferably, the method is performed independently in a plurality of frequency bands, i.e., each of the first and second input signals is divided into the plurality of frequency bands, and a respective control parameter is determined and a beamformer signal is derived in each of some, and preferably each of all, frequency bands, such that the respective control parameter preferably controls the corresponding beamformer's adaptation speed in each of the frequency bands.

Preferably, an output signal of the hearing device is derived from the beamformer signal (i.e., after the proposed method for directional noise reduction has been applied), and the output signal is converted into an output sound signal by an electro-acoustic output transducer of the hearing device. Such an electro-acoustic output transducer is any device which is designed and configured to convert an electrical signal into a corresponding sound signal, whereby voltage and/or current fluctuations in the electrical signal are converted into corresponding amplitude fluctuations in the sound signal, i.e. in particular a loudspeaker, a so-called balanced metal case receiver, but also a bone conduction receiver.

Other features which are considered as characteristic for the invention are set forth in the appended claims.

Although the invention is illustrated and described herein as embodied in a method for directional noise suppression in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic and simplified illustration of a hearing device;

FIG. 2 is a schematic illustration of a top view of a user in the presence of a conversation partner and the directional characteristic of a corresponding beamformer signal attenuating a lateral interferer;

FIG. 3 is a schematic diagram of two level meters reacting to sound impulses on top of a stationary noise background; and

FIG. 4 is a schematic block diagram of a signal flow for the method according to the invention, to be performed by the hearing device of FIG. 1.

Parts and variables which correspond to one another are provided with the same reference signs throughout the figures.

### DETAILED DESCRIPTION OF THE INVENTION

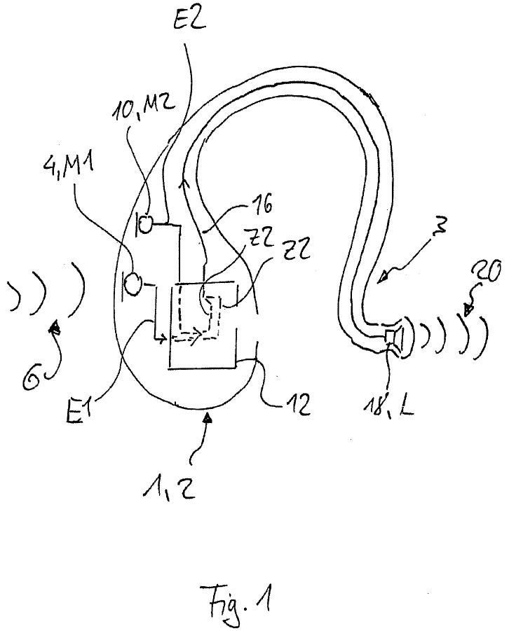

Referring now to the figures of the drawing in detail and first, in particular, to FIG. 1 thereof, there is shown a schematic and simplified illustration of a hearing device 1. The hearing device 1 is a hearing aid 2 configured to compensate, at least partially, for the hearing impairment of a hearing-impaired user. It will be understood, however, that the invention is not restricted to hearing aids, and may be implemented by other hearing devices, such as communication devices or ear-bud type hearing devices configured to provide an additional assistance functionality to a user. The hearing aid 2 of FIG. 1 is shown as a so-called Behind-The-Ear (BTE) type with an earpiece 3, or receiver. The hearing aid 2 may also be an In-The-Ear (ITE) hearing device, a Receiver-In-the-Canal (RIC) device, a Completely-In-the-Canal (CIC) type device, or other suitable forms.

In terms of its functional components, the hearing device 1 comprises an acousto-electric first input transducer 4 which is configured to convert an environment sound 6 into an electric first input signal E1, wherein the air pressure fluctuations caused by the sound waves of the environment sound 6 are converted into corresponding voltage and/or current fluctuations of the first input signal E1. The first input transducer 4 in the embodiment shown in FIG. 1 is a first microphone M1. The hearing device 1 also comprises a second acousto-electric input transducer 10, generating a corresponding electric second input signal E2, for a directional processing of the generated input signals E1 and E2. The second input transducer 10 in the embodiment shown in FIG. 1 is a second microphone M2.

The hearing device 1 comprises a signal processing unit 12, or signal processor 12, which in the present embodiment shall include all signal processing means of the hearing device 1, e.g., one or more signal processors, a RAM that is addressable via said signal processor(s), a non-volatile memory for storing signal processing algorithms and corresponding parameters, and possibly one or several ASICs and/or other hard-wired circuitry. In the present embodiment of the hearing device 1 being given by the hearing aid 2, the non-volatile memory of the signal processing unit 12 also stores information on the audiological needs of the user, e.g., an audiogram and the like.

The first input signal E1 and the second input signal E2 are processed in the signal processing unit 12, thereby generating a first intermediate audio signal Z1 and a second intermediate audio signal Z2, into a 38 beamformer signal (not shown in FIG. 1), said beamformer signal being further processed into an output signal 16, wherein said signal processing in particular may include frequency-dependent amplification and/or compression, as well as noise reduction. Preferably, said signal processing in the present case is being performed in dependence on said audiological needs of the user. However, in a more general case, the signal processing may also contain algorithms that are performed on the basis of general benchmarks (such as SNR improvement and the like).

The output signal 16 is fed to an electro-acoustic output transducer 18 located in the earpiece 3, said output transducer 18 being designed and configured to convert the output signal 16 into a corresponding output sound signal 20 which is presented to the hearing (i.e., to the tympanum, ear drum, or to the cranial bone near the ear) of the user. The output transducer 18 in the present case is shown as a loudspeaker L, but could be a bone conduction receiver or another suitable sound generating apparatus.

Note that the hearing device 1 may also be a binaural hearing system with two local devices, each of which containing one of the input transducers 4, 10, in a way already described above.

In an embodiment, the beamformer is configured to generate the beamformer signal in a way such that a sensitivity of the beamformer signal in a reference direction has at least one of a predetermined value, and a value that is independent of changes of a position of an interferer located outside of said reference direction. In particular, the latter may comprise that the sensitivity in the reference direction does not depend on the position of an interferer who is located, preferably at a position at least 45° and most preferably at least 60° degrees away from the reference direction, so that if the interferer changes his angular position (but staying at least 45° and most preferably at least 60° degrees away from the reference direction), the sensitivity in the reference direction remains unaffected by this change.

Preferably, the reference direction may be a frontal direction of the user of the hearing device, assuming that the hearing device is worn in the proper way and position at the user's ear. In that case, the sensitivity in the frontal direction is preferably unaffected by a change of the angular position of an interferer at a lateral or rear position (i.e., located from −45° or −70° or −90° to −180° or from 45° or 70° or 90° to 180° with respect to the frontal position).

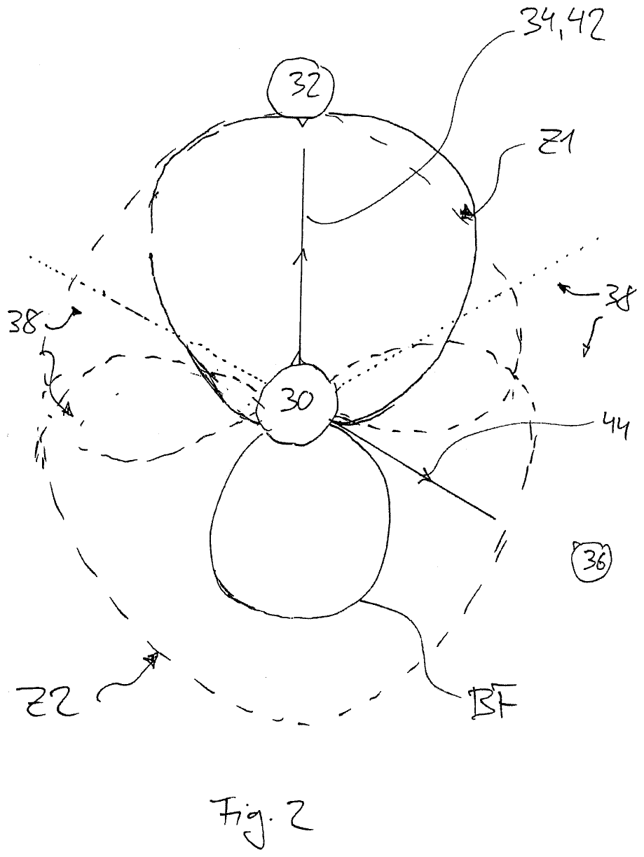

This is illustrated in FIG. 2. FIG. 2 shows a user 30 of the hearing device 1 of FIG. 1, in a specific hearing situation, in which the user 30 is in conversation with a speaker 32 located in a frontal direction 34 of the user, in the presence of a lateral interferer 36 (given, in the present embodiment, by another person not involved in said conversation). The lateral interferer 36 is located in an area 38 outside the cone between +60° and −60° with respect to the frontal direction 34 of the user 30. In FIG. 2, the lateral interferer is depicted at an angle of approx. 120°, however, the interferer could be located anywhere in the area 38 (delimited by dotted lines).

Then, in a preferred embodiment, the signal processing of the hearing device 1 derives a first intermediate signal Z1 from both the first input signal and the second input signal, said first intermediate signal Z1 showing a maximum attenuation in a first null direction 40. Furthermore, the signal processing of the hearing device 1 preferably derives a second intermediate signal Z2 from both the first input signal and the second input signal, said second intermediate signal Z2 showing a maximum attenuation in a second null direction 42 distinct from said first null direction 40, wherein said beamformer signal is derived from said first intermediate signal Z1 and said second intermediate signal Z2. In FIG. 2, the intermediate signals Z1 and Z2 are represented by their respective directional characteristics (dashed lines).

The first intermediate signal Z1 is given by a cardioid-shaped signal so that the first null direction 40 is given by the opposite of the frontal direction 34, while the second intermediate signal Z1 is given by an anti-cardioid-shaped signal, and thus, the second null direction 42 is exactly the frontal direction 34.

The first and the second intermediate signal Z1, Z2 each are derived from the two input signals E1, E2 as time-delayed and possibly weighted superpositions, i.e., the signal contributions of one of the input signals E1, E2 are delayed, preferably by the time corresponding to the propagation of sound along the distance between the first microphone M1 and the second microphone M2, possibly weighted, and subtracted from the signal contributions of the respective other input signal E1, E2. Preferably, each of the input signals E1, E2 is an omnidirectional signal (at least, when not accounting for any shadowing effects of the user's pinna and head).

In a way yet to be described, a beamformer signal BF is formed from the first and second intermediate signal Z1, Z2, which is configured to attenuate the contributions of the interferer 36 in the output sound signal 20 presented to the user 30. The beamformer signal BF is formed as a weighted superposition of the first and second intermediate signal Z1, Z2 in a way that a maximal attenuation is achieved for the direction 44 of the interferer 36. Again, in FIG. 2, the beamformer signal BF is represented by is directional characteristic (solid line). This in particular includes that BF may be of the form Z1+α·Z2 (with α being a suitable real or complex number to be determined in a way yet to be described), such that in the frontal direction 34 (where the anti-cardioid-shaped second intermediate signal Z2 has a total attenuation), changes made to the term α·Z2 will not have any influence on the sensitivity of the beamformer signal BF there. This reflects the fact that typically, the user 30 will direct his view towards a target, i.e., a source of a useful sound (such as the speaker 32), and any beamforming for attenuating a lateral or rear interferer 36 should most preferably not affect the beamformer signal BF in this target direction.

In yet another embodiment, the method further comprises the step of determining said control parameter by means of a first level meter and a second level meter, said first level meter and second level meter both being applied to one out of: the first input signal, the second input signal, and a control signal derived from the first input signal and/or from the second input signal. Preferably, the first and second level meter are applied to the same of the above-mentioned signals. In particular, the control signal can be derived from the first and the second signal, preferably by a directional signal processing, i.e., the control signal preferably has a directional characteristic with reduced sensitivity in the target direction (e.g., the control signal can be the anti-cardioid-shaped second intermediate signal Z2).

Expediently, said control parameter is determined on the basis of a comparison function or a difference of the outputs of the first level meter and the second level meter. This comprises that for a given instant, a comparison function such as, e.g., a quotient or a logarithmic difference (possibly with pre-factors), of the output values of the first and the second level meter is calculated, or the (“normal”) difference of these output values. The control parameter can either be taken as the result of this comparison function or difference, or can be taken as a monotonous (and preferably inflection-less) function of said comparison function or difference, respectively.

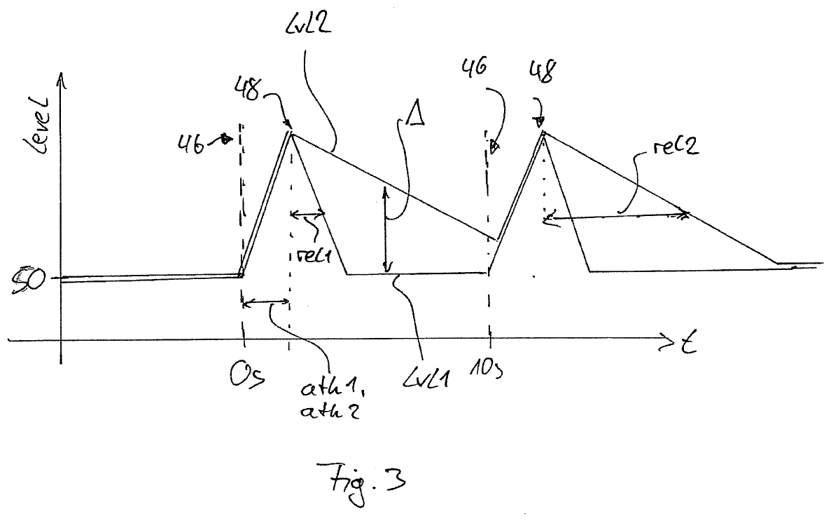

In another advantageous embodiment, said first level meter has a short first attack time and a long first release time, while said second level meter has a long second attack time and a long second release time, or said first level meter has a short first attack time and a short first release time, while said second level meter has a short second attack time and a long second release time. This is shown in FIG. 3, which displays the outputs of a first level meter lvl1 and a second level meter lvl2 in a given signal (preferably, in a frequency band of the signal), plotted against the time t, while reacting to an impulse-like sound event 46 starting at t=0 s (dashed line), over a stationary noise floor. In particular, those level meters lvl1, lvl2 may have different parametrizations regarding attack and/or release times and/or regarding overall sensitivity, so that differences in the level meters lvl1, lvl2 allow for the detection of stationary noise in the corresponding frequency band. A level meter is very easy to implement, e.g., via (recursive) low-pass filters (which may be of 1^{st} order), and thus allows for an easy detection of stationary noise.

In particular, said first level meter lvl1 has a short first attack time atk1 and a short first release time rel1, wherein said second level meter lvl2 has a short second attack time atk2 (which may be identical to the first attack time atk1) and a long second release time rel2 (longer than the first release time rel1). Preferably, the control parameter is then determined on the basis of a comparison function (not shown) or on the basis of a difference D of an output of the first level meter lvl1 and an output of the second level meter lvl2.

In FIG. 3, the second level meter lvl2, follows the first level meter lvl1 due to their identical (fast) attack times atk1=atk2, while after reaching a peak 48, due to its slower second release time rel2, the second level meter lvl2 shows a slower fall-off after the peak 48 than the first level meter lvl1. The first and second release times rel1, rel2 are defined with respect to the output of the corresponding level meter lvl1, lvl2 falling to half the level of the peak value at the peak 48. For better illustration, at t=10 s, another impulse-like sound event 46 happens, leading to corresponding rising contributions in the outputs of the level meters lvl1, lvl2, and affecting the difference D of their outputs accordingly, before they again converge to zero, i.e., when only the stationary background noise yields contributions. Note that between the two sound events 46, the output of the second level meter lvl2 does not reach its base value 50 of the stationary background noise.

In another embodiment, the method further comprises the step of deriving the beamformer signal as a solution to an optimization problem of an objective function which is related to an instantaneous signal energy of the beamformer signal to be optimized. Said optimization problem in particular may be given by minimizing the objective function with respect to the beamformer signal, such that updating the beamformer signal from a time step n to a time step n+1 in the optimization leads also to an update in the beamformer signal's internal parameters (such as the parameter or parameters controlling the direction of a maximal attenuation).

Preferably, said optimization problem is given by a least mean squares algorithm or a normalized least mean squares algorithm of the signal energy of the beamformer signal.

This in particular includes that BF may be of the form Z1+α·Z2, and being subject to the optimization

BF∝argmin_{α}E{|Z1+·Z2|²} (i)

with E {|Z1+·Z2|²} being the expectation value of the signal energy.

Expediently, the method further comprises the step of controlling a step size of an adaptive solution to the optimization problem (e.g., the optimization problem of equation (i)) on the basis of said control parameter. This may in particular comprise that during an updating process from a time step n to a time step n+1, the parameter a (n) gets updated to a (n+1)=α(n)+μ·D, wherein D is a function of the signal energy and possibly other signal benchmarks, and μ is a step size characterizing the convergence speed of the solution of the underlying optimization problem (such as the one given by equation (i)). Then, μ is given as a function of said control parameter characterizing the stationarity of noise.

Preferably, said step size μ shows a monotonically increasing dependence on the stationarity as characterized by the control parameter, i.e., the step size μ increases if the stationarity (as indicated by the control parameter) increases, and the step size μ most preferably decreases if the stationarity decreases.

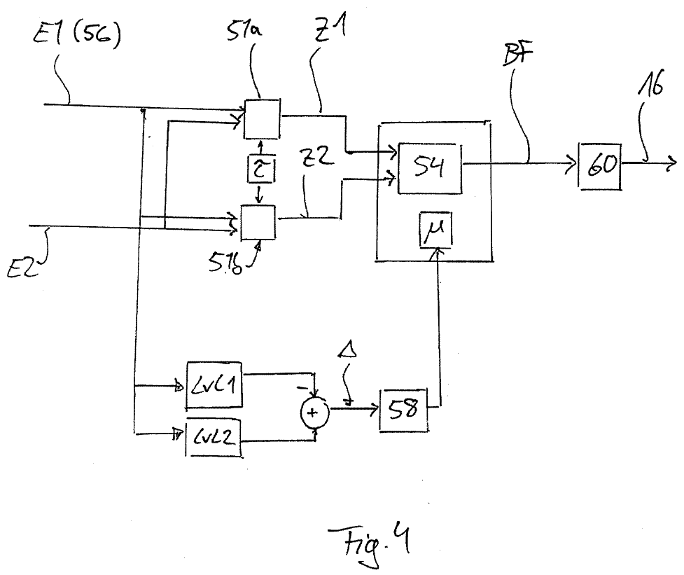

FIG. 4 shows a schematic block diagram of a signal flow for a noise reduction method according to the invention. The method is to be performed by the hearing device 1 of FIG. 1, and in particular, by its signal processing unit 12, or processor 12. That is, the entire signal flow shown in FIG. 4 may be performed in the signal processing unit 12.

For the signal flow, the first intermediate signal Z1 is derived by means of a time-delayed and possibly weighted superposition 51a (i.e., a superposition in which a relative time delay t between the signal components of the two input signals E1, E2 is introduced) from the first and the second input signal E1, E2. Likewise, by another time-delayed and possibly weighted superposition 51b (with different signs for the input signal components) of the first and the second input signal E1, E2, the second intermediate signal Z2 is derived. The first intermediate signal Z1 and the second intermediate signal Z2 are passed to a beamformer 52, in which the beamformer signal BF is generated from the intermediate signals Z1, Z2 by means of an optimization 54. The optimization 54 ensures that the signal power of the beamformer signal BF is minimized for each moment, under the constraint that the sensitivity of the beamformer signal BF in the frontal direction 34 (c.f. FIG. 2) shall not be affected.

The first input signal E1 is furthermore taken as a reference signal 56, and the first and second level meter lvl1, lvl2 (c.f. FIG. 3) are applied to the reference signal 56. Note that instead of the first input signal E1, the second input signal E2 or a superposition of the first and the second input signal E1, E2, such as, e.g., the anti-cardioid-shaped second intermediate signal Z2, could be taken as the reference signal 56. As seen in FIG. 3, the difference D is taken from the two level meters lvl1, lvl2, and a control parameter 58 characterizing the signal stationarity of the reference signal 56 is derived from said difference D.

This control parameter 58 is now used to control a step size μ of an adaptation in the optimization 54 used to generate the beamformer signal BF. For the difference D indicating a low stationarity (i.e., a comparatively large difference, possibly in the order of the values of one of the level meters lvl1, lvl2), the step size μ attains a comparatively large value, ensuring that the beamformer signal BF will adapt to an interferer sufficiently quickly. For the difference D indicating a high stationarity (i.e., a difference close or equal to zero), the step size μ attains a comparatively small value, keeping the adaptation of the beamformer signal BF slower.

Note that the entire generation of the beamformer signal BF may be performed independently in different frequency bands (not shown), i.e., the input signals E1, E2 each are divided into respective pluralities of frequency bands, and the process of stationarity-based control of the beamformer is applied individually in each frequency band.

The beamformer signal BF is further processed (e.g., by further frequency-dependent amplification, possibly depending also on the audiological needs of the user 30) into the output signal 16 of FIG. 1. Note that this further processing 60 may also be trivial, i.e., the signal contributions of the beamformer signal BF may be directly taken as the output signal 16 (after synthesis to a broadband signal).

Although the invention has been illustrated and described in more detail by the preferred embodiment example, the invention is not limited by the disclosed examples and other variations may be derived by the skilled person without departing from the scope of protection of the invention.

The following is a summary list of reference numerals and the corresponding structure used in the above description of the invention:
1 hearing device
2 hearing aid
3 earpiece
4 first input transducer
6 environment sound
10 second input transducer
12 signal processing unit
16 output signal
18 output transducer
20 output sound signal
30 user
32 speaker
34 frontal direction (of the user)
36 lateral interferer
38 area
40 first null direction
42 second null direction
44 direction (of the interferer 36)
46 (impulse-like) sound event
48 peak
50 base value
51a/b time-delayed superposition
52 beamformer
54 optimization
56 reference signal
58 control parameter
atk1/2 first/second attack time
BF beamformer signal
E1/2 first/second input signal
L loudspeaker
lvl1/2 first/second level meter output
M1/2 first/second microphone
rel1/2 first/second release time
t time
Z1/2 first/second intermediate signal
D difference (of first and second level meter output)
μ step size
t time delay

1. A method for directional noise suppression in a hearing device, the hearing device having a first acousto-electric input transducer configured to generate a first input signal from an environment sound and a second acousto-electric input transducer configured to generate a second input signal from the environment sound, the method comprising:
determining, on a basis of at least one of the first input signal or the second input signal, a control parameter that characterizes a stationarity of a noise component in the environment sound;
deriving a beamformer signal from the first input signal and from the second input signal by a beamformer, the beamformer signal being configured to attenuate a contribution of a noise component in the environment represented in at least one of the first input signal or the second input signal; and
controlling an adaptation speed of the beamformer on a basis of the control parameter.

2. The method according to claim 1, generating the beamformer signal by the beamformer such that a sensitivity of the beamformer signal in a reference direction has at least one of:
a predetermined value; or
a value that is independent of changes of a position of an interferer located outside of the reference direction.

3. The method according to claim 1, further comprising:
deriving a first intermediate signal from both the first input signal and the second input signal, the first intermediate signal showing a maximum attenuation in a first null direction; and
deriving the beamformer signal from the first intermediate signal.

4. The method according to claim 3, wherein the first intermediate signal is a cardioid-shaped signal or an anti-cardioid-shaped signal.

5. The method according to claim 3, further comprising:
deriving a second intermediate signal from both the first input signal and the second input signal, the second intermediate signal showing a maximum attenuation in a second null direction distinct from the first null direction; and
deriving said beamformer signal from the first intermediate signal and the second intermediate signal.

6. The method according to claim 5, wherein:
the first intermediate signal is a cardioid-shaped signal; and
the second intermediate signal is an anti-cardioid-shaped signal.

7. The method according to claim 1, which comprises deriving the beamformer signal as a solution to an optimization problem of an objective function which is related to an instantaneous signal energy of the beamformer signal to be optimized.

8. The method according to claim 7, wherein the optimization problem is a least mean squares algorithm or a normalized least mean squares algorithm minimizing the signal energy of the beamformer signal.

9. The method according to claim 7, which comprises controlling a step size of an adaptive solution to the optimization problem on a basis of the control parameter.

10. The method according to claim 9, wherein the step size shows a monotonically increasing dependence on the stationarity characterized by the control parameter.

11. The method according to claim 1, which comprises:
determining the control parameter by way of a first level meter and a second level meter, with the first level meter and the second level meter both being applied to a signal selected from the group consisting of:
the first input signal, the second input signal, a control signal derived from at least one of the first input signal or the second input signal.

12. The method according to claim 11, which comprises determining the control parameter on a basis of a comparison function or a difference of an output of the first level meter and an output of the second level meter.

13. The method according to claim 11, wherein one of the following is true:
the first level meter has a short first attack time and a long first release time, while said second level meter has a long second attack time and a long second release time; or
the first level meter has a short first attack time and a short first release time, while said second level meter has a short second attack time and a long second release time.

14. A hearing device, comprising:
an acousto-electric first input transducer configured to generate a first input signal from an environment sound;
an acousto-electric second input transducer configured to generate a second input signal from the environment sound; and
at least one signal processing unit configured to carry out the method according to claim 1.
